(19) United States
(12) Patent Application Publication
(10) Pub. No.: US 2023/0274280 A1
(43) Pub. Date: Aug. 31, 2023

(54) DYNAMICALLY POPULATED USER INTERFACE FEATURE

(71) Applicant: Shopify Inc., Ottawa (CA)

(72) Inventors: Carmen SPITZ, Montreal (CA); Dylan KENDAL, Montreal (CA); Krystian CZESAK, Montreal (CA); Mohammad Hashemi AGHCHEHBODY, Ottawa (CA); Philibert DUGAS, Terrebonne (CA); Pierre NESPO, Saint-lambert (CA); Youcef MSAID, Montreal (CA); Chaim Joshua NUSSBAUM, Montreal (CA)

(73) Assignee: Shopify Inc., Ottawa, ON (CA)

(21) Appl. No.: 18/311,321

(22) Filed: May 3, 2023

Related U.S. Application Data
(63) Continuation of application No. 15/998,568, filed on Aug. 15, 2018.

(51) Int. Cl. G06Q 20/40; G06Q 30/0601; G06F 16/951

(52) U.S. Cl. CPC G06Q 20/4014; G06F 16/951; G06Q 30/0641

(57) ABSTRACT

Systems, devices and methods that receive data indicative of a description of a product or service available for purchase from a merchant including software instructions that cause the device to perform steps for determining whether a user of the device is recognized by one or more payment processors as having an existing account with each payment processor, and wherein, when the user is identified as having an account with more than one payment processor, the software instructions cause the device to choose a payment processor from the payment processors with whom the user of the device has an account, and wherein the software instructions cause the device to present a payment processor-specific checkout element that identifies the chosen payment processor and to begin the payment process for the product or service with the chosen payment processor upon a user selection of the payment processor-specific checkout element.

### CROSS-REFERENCE TO RELATED APPLICATIONS

The present application is a continuation of U.S. Pat. Application Serial No. 15/998,568, filed Aug. 15, 2018, the contents of which are hereby incorporated by reference.

### BACKGROUND

In the past, merchant websites presenting webpages displaying products for sale have presented users with add-to-cart buttons which direct users to click the button to place a product into a virtual cart and either continue shopping or, from a display showing the virtual cart, proceed to a checkout webpage. However, many online consumers do not add multiple items to a virtual cart in a single session on a merchant website but rather would prefer to proceed to check out immediately from a product page because they only desire to purchase a single product from the merchant. In this instance, the consumer is discouraged by extra clicks or prone to reconsider based upon the additional time it takes to cycle through a shopping cart and proceed to purchase. Therefore, the extra process represents an annoyance for consumers and could result in a deferred or declined purchase.

However, avoiding the shopping cart and checkout process present alternative challenges because, at least, during the checkout process one of many payments types must be requested and selected by the consumer. If buttons for each payment type are placed on a product page, the page appears cluttered with payment options and is not attractive or is confusing to consumers. Some payment types may not even apply to all consumers, as they may not have an account with that payment processor and the extra buttons represent a distraction.

All of these factors can lead to higher purchase abandonment, and thereby lower visitor/sales conversion rates and gross merchandise volume for web merchants.

### SUMMARY

In accordance with exemplary and non-limiting embodiments, a device is provided comprising a processor and a computer-readable storage device that stores instructions that, when executed by the processor, cause the processor to perform operations. The operations comprise receiving data indicative of a description of a product or service available for purchase from a merchant wherein the data includes software instructions for execution by the device; and wherein the software instructions cause the device to perform steps for determining whether a user of the device is recognized by one or more payment processors as having an existing account with each payment processor, and wherein, when the user is identified as having an account with more than one payment processor, the software instructions cause the device to choose a payment processor from the payment processors with whom the user of the device has an account, and wherein the software instructions cause the device to present a payment processor-specific checkout element that identifies the chosen payment processor and to begin the payment process for the product or service with the chosen payment processor upon a user selection of the payment processor-specific checkout element.

In embodiments of the device, the software instructions that cause the device to perform steps for determining whether the user of the device is recognized by one or more payment processors as having an existing account with the payment processor comprises at least one of: software instructions for executing an application programming interface of the device, software instructions for examining a cookie associated with device, software instructions for examining properties of a browser or device, or software instructions for querying at least one payment processor or for receiving an associated response.

In embodiments of the device, the data comprises a webpage comprising a detailed description of the product or service available for purchase.

In embodiments of the device, the data is a webpage displaying the product or service in a virtual shopping cart.

In embodiments of the device, the payment processor-specific checkout element is a button that comprises at least one of a textual or design element identifying the chosen payment processor.

In embodiments of the device, upon a user selection of the payment processor-specific checkout element, the software instructions cause initiation of an authentication process with the chosen payment processor to authenticate the user.

In embodiments of the device, the payment processor-specific checkout element is not presented to the user until the chosen payment processor is determined.

In embodiments of the device, the chosen payment processor is selected from the payment processors with whom the user is indicated as having an existing account according to an order of preference.

In embodiments of the device, the software instructions cause the chosen payment processor to authenticate the user using authentication hardware associated with the device.

In embodiments of the device, the authentication hardware associated with the device is a fingerprint reader.

In embodiments of the device, the software instructions cause the device to choose a payment processor from the payment processors with whom the user of the device has an account based on geolocation data of the device.

In embodiments of the device, the software instructions cause the device to determine a method of communicating with each payment processor based upon the identity of the payment processor.

In embodiments of the device, the software instructions causing the device to determine whether a user of the device is recognized by one or more payment processors as having an existing account comprises, for at least one of the payment processors, software instructions that direct the device to initiate a query across a network to the payment processor for determining whether the has an account with that payment processor.

In embodiments of the device, the chosen payment processor is selected from the payment processors with whom the user is indicated as having an existing account according to a scoring process.

In embodiments of the device, the scoring process calculates scores for individual payment processors and comprises scoring the payment processors, at least in part, according to a speed at which each payment processor is identified as a payment processor with whom the user of the device has an account.

In embodiments of the device, the scoring process iteratively calculates scores at predetermined time intervals.

In embodiments of the device, the software instructions, at the predetermined time intervals, determines whether each payment processor has identified as a payment processor with whom the user of the device has an account and calculate scores for each of the payment processors.

In embodiments of the device, the software instructions, at the predetermined time intervals, compare the scores of each payment processor with a score threshold and choose the payment processor when a payment processor’s score exceeds the threshold.

In embodiments of the device, the software instructions, at the predetermined time intervals, cause the threshold to decrease as a function of time.

In embodiments of the device, the payment processor-specific checkout element further comprises a user display element that displays payment processors that are not the chosen payment processor, but for which the software instructions determined that the user has an existing account.

In embodiments of the device, the user display element is configured to display the payment processors that are not the chosen payment processor in a preference order.

In other embodiments, a computer-implemented method comprises presenting a description of a product or service available for purchase from a merchant on a client device; determining whether a user of the client device is recognized by one or more payment processors as having an existing account with each payment processor; when the user is identified as having an account with more than one payment processor, choosing a payment processor from the payment processors with whom the user of the client device has an account; and presenting a payment processor-specific checkout element that identifies the chosen payment processor and begins the payment process for the product or service with the chosen payment processor upon a user selection of the payment processor-specific checkout element.

In embodiments of the method, the step of determining whether the user of the client device is recognized by one or more payment processors as having an existing account with the payment processor comprises the step of performing at one least of: executing an application programming interface, examining a cookie associated with client device, examining properties of a client browser or client device, or querying at least one payment processor or for receiving an associated response.

In embodiments of the method, the step of presenting a description of a product or service available for purchase from a merchant on a client device comprises the step of the step of presenting a webpage comprising a detailed description of the product or service available for purchase.

In embodiments of the method, the step of presenting a description of a product or service available for purchase from a merchant on a client device comprises the step of presenting the product or service in a virtual shopping cart.

In embodiments of the method, the payment processor-specific checkout element is a button that comprises at least one of a textual or design element identifying the chosen payment processor.

In embodiments of the method, upon a user selection of the payment processor-specific checkout element, initiating an authentication process with the chosen payment processor to authenticate the user.

In embodiments of the method, the payment processor-specific checkout element is not presented to the user until the chosen payment processor is determined.

In embodiments of the method, the chosen payment processor is selected from the payment processors with whom the user is indicated as having an existing account according to an order of preference.

In embodiments of the method, authenticating the user using authentication hardware associated with the client device.

In embodiments of the method, the authentication hardware associated with the client device is a fingerprint reader.

In embodiments of the method, the step of choosing a payment processor from the payment processors with whom the user of the client device has an account comprises the step of choosing a payment processor from the payment processors with whom the user of the client device has an account based on geolocation data of the client device.

In embodiments of the method, determining a method of communicating with each payment processor based upon the identity of the payment processor.

In embodiments of the method, further performing the steps of determining whether a user of the client device is recognized by one or more payment processors as having an existing account comprises the step of, for at least one of the payment processors, direct the client device to initiate a query across a network to the payment processor for determining whether the client has an account with that payment processor.

In embodiments of the method, the chosen payment processor is selected from the payment processors with whom the user is indicated as having an existing account according to a scoring process.

In embodiments of the method, the scoring process comprises the steps of calculating scores for individual payment processor, the scores based at least in part, upon a speed at which each payment processor is identified as a payment processor with whom the user of the client device has an account.

In embodiments of the method, the steps of calculating scores for individual payment processors comprises iteratively calculating scores at predetermined time intervals.

In embodiments of the method, the step of iteratively calculating scores at predetermined time intervals comprises the steps of determining whether each payment processor has been identified as a payment processor with whom the user of the client device has an account and calculating scores for each of the payment processors.

In embodiments of the method, the process further comprises the steps of, at the predetermined time intervals, comparing the scores of each payment processor with a score threshold and choosing the payment processor when a payment processor’s score exceeds the threshold.

In embodiments of the method, the method further comprises the steps of, at the predetermined time intervals, causing the threshold to decrease as a function of time.

In embodiments of the method, the payment processor-specific checkout element further comprises a user display element that displays payment processors that are not the chosen payment processor, but for which the software instructions determined that the user has an existing account.

In embodiments of the method, the user display element is configured to display the payment processors that are not the chosen payment processor in a preference order.

In embodiments, a system comprises a server computer comprising a processor and a computer-readable storage device that stores instructions that, when executed by the processor, cause the processor to perform operations. The operations comprise transmitting data to a client device which causes the client device to present a description of a product or service available for purchase from a merchant wherein the data includes software instructions for execution by the client device, wherein the software instructions cause the client device to perform steps for determining whether a user of the client device is recognized by one or more payment processors as having an existing account with each payment processor, wherein, when the user is identified as having an account with more than one payment processor, the software instructions cause the client device to choose a payment processor from the payment processors with whom the user of the client device has an account, and wherein the software instructions cause the client device to present a payment processor-specific checkout element that identifies the chosen payment processor and to begin the payment process for the product or service with the chosen payment processor upon a user selection of the payment processor-specific checkout element.

In embodiments of the system, software instructions cause the client device to perform steps for determining whether the user of the client device is recognized by one or more payment processors as having an existing account with the payment processor comprises at least one of: software instructions for executing an application programming interface of the client device, software instructions for examining a cookie associated with client device, software instructions for examining properties of a client browser or client device, or software instructions for querying at least one payment processor or for receiving an associated response.

In embodiments of the system, the data is a webpage comprising a detailed description of the product or service available for purchase.

In embodiments of the system, the data is a webpage displaying the product or service in a virtual shopping cart.

In embodiments of the system, the payment processor-specific checkout element is a button that comprises at least one of a textual or design element identifying the chosen payment processor.

In embodiments of the system, upon a user selection of the payment processor-specific checkout element, the software instructions cause initiation of an authentication process with the chosen payment processor to authenticate the user.

In embodiments of the system, the payment processor-specific checkout element is not presented to the user until the chosen payment processor is determined.

In embodiments of the system, the chosen payment processor is selected from the payment processors with whom the user is indicated as having an existing account according to an order of preference.

In embodiments of the system, the software instructions cause the chosen payment processor to authenticate the user using authentication hardware associated with the client device.

In embodiments of the system, the authentication hardware associated with the client device is a fingerprint reader.

In embodiments of the system, the software instructions cause the client device to choose a payment processor from the payment processors with whom the user of the client device has an account based on geolocation data of the client device.

In embodiments of the system, the software instructions cause the device to determine a method of communicating with each payment processor based upon the identity of the payment processor.

In embodiments of the system, the software instructions causing the client device to determine whether a user of the client device is recognized by one or more payment processors as having an existing account comprises, for at least one of the payment processors, software instructions that direct the client device to initiate a query across a network to the payment processor for determining whether the client has an account with that payment processor.

In embodiments of the system, the chosen payment processor is selected from the payment processors with whom the user is indicated as having an existing account according to a scoring process.

In embodiments of the system, the scoring process calculates scores for individual payment processors and comprises scoring the payment processors, at least in part, according to a speed at which each payment processor is identified as a payment processor with whom the user of the client device has an account.

In embodiments of the system, the scoring process iteratively calculates scores at predetermined time intervals.

In embodiments of the system, the software instructions, at the predetermined time intervals: determine whether each payment processor has identified as a payment processor with whom the user of the client device has an account and calculate scores for each of the payment processors.

In embodiments of the system, the software instructions, at the predetermined time intervals, compare the scores of each payment processor with a score threshold and choose the payment processor when a payment processor’s score exceeds the threshold.

In embodiments of the system, the software instructions, at the predetermined time intervals, cause the threshold to decrease as a function of time.

In embodiments of the system, the payment processor-specific checkout element further comprises a user display element that displays payment processors that are not the chosen payment processor, but for which the software instructions determined that the user has an existing account.

In embodiments of the system, the user display element is configured to display the payment processors that are not the chosen payment processor in a preference order.

### BRIEF DESCRIPTION OF THE FIGURES

FIG. 1 is a diagram of a platform according to an embodiment;

FIG. 2 is a flow chart according to an embodiment;

FIG. 3 is a view of a product webpage from a sample merchant website according to an embodiment;

FIG. 4 is a view of an order summary webpage from a sample merchant website according to an embodiment;

FIG. 5 is a view of an authentication webpage from a sample merchant website according to an embodiment;

FIG. 6 is a flow chart according to an embodiment;

FIG. 7 is a diagram of the selection process for a payment processor according to an embodiment.

FIG. 8 is a view of a product webpage from a sample merchant website according to an embodiment;

FIG. 9 is a view of a product webpage from a sample merchant website according to an embodiment;

FIG. 10 is a view of an order summary webpage from a sample merchant website according to an embodiment; and

FIG. 11 is a view of an authentication webpage from a sample merchant website according to an embodiment.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

In an embodiment, the present disclosure relates to making it easier for merchants to sell and for consumers to buy through Internet and electronic commerce, including through the world wide web and apps and through point of sale devices, such as in brick and mortar retail settings.

Electronic merchants put great effort into attracting consumers to the point where they click a ‘buy’ button, thereby making it important for the purchasing process to be as frictionless as possible. The gain in popularity of mobile devices amplifies the need to address clutter and checkout options in pages that offer products or services for sale, because smaller screen sizes make viewing pages and required consumer input more challenging. Additionally, consumers having to enter details, such as contact information, shipping information, payment card information, etc. creates friction in the checkout process. By eliminating these consumer pain points, a more positive shopping experience and better sales outcomes can be realized.

The present disclosure is aimed at reducing payment and data input friction by intelligently determining the most appropriate payment method or methods for a consumer, presenting only that or those methods to the consumer on a product or service purchase page or order summary page and/or reducing the need for repetitive manual user input. The appropriate payment methods may be presented on an ecommerce or a point sale device in a physical store environment. The payment methods may be presented in many different ways (e.g. as described below), on any type of display page or any type of device, including a point of sale device. The present disclosure also aims to present such accelerated payment options when most likely to be used and where purchase friction can be reduced and/or minimized. In the present disclosure, this goal is achieved by adding processes and software to determine the available and most appropriate or most preferred payment method or methods. Then only those methods are displayed to the consumer and inappropriate payment methods are not displayed to the consumer. This streamlined display of information is achieved by a process whereby information is obtained by querying payment processors (or data related to payment processors or users) or by gathering information regarding consumer behavior across multiple online retailer sites and, in an embodiment, where browsers enable consumer information to be stored and used to present payment processors without further action from the consumers. In an embodiment, the determination of the identity of appropriate payment processor(s) is performed by software provided to a consumer device, so that the existence of or non-existence of a customer’s payments accounts is not revealed to a merchant. In an embodiment, device, browser and geolocation information are used to assist in the determination of any appropriate (or the most appropriate) payment method or contact information to be used for a transaction. Additionally, other data can be used to determine an appropriate payment method, such as device information including a device ID, type of device and capabilities of the device, such as screen size, language, presence of keyboard, etc.

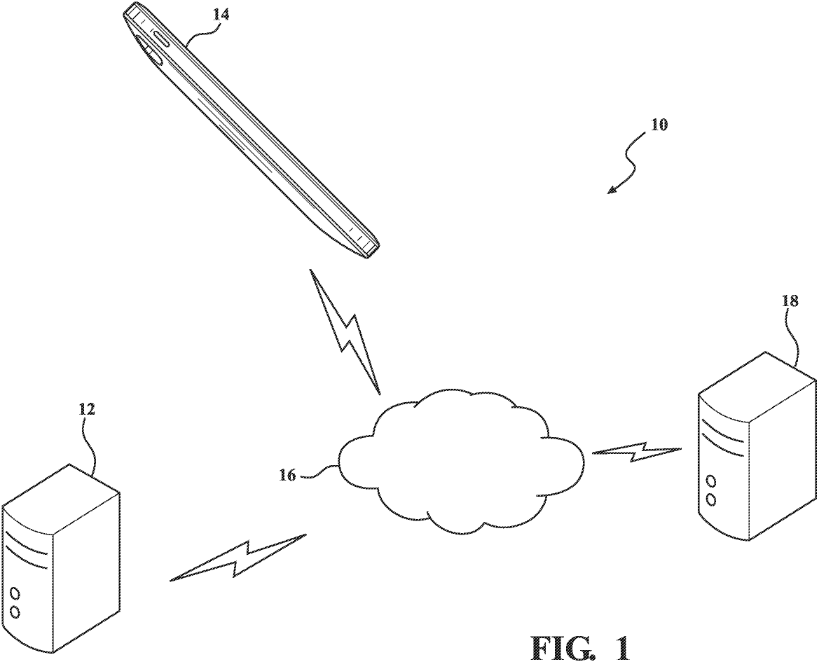

In an embodiment, and referring to FIG. 1, there is provided a platform for presenting a good or service for sale in an online marketplace comprising one or more marketplace servers 12 for hosting the online marketplace and responding to queries by a plurality of consumer devices 14 to communicate to the consumer device for displays for presenting products and services for sale and for completing transactions. The marketplace server 12 and the consumer device 14 each communicate with one another via a computer network 16, such as a wide area network. Furthermore, the platform 10 comprises one or more payment servers 18, any one of which may be hosted by a third party or by the same party as the merchant or marketplace server 12. The payment server 18 is in communication with the marketplace server 12 and consumer device 14 through the wide area network to respond to queries from both the marketplace server 12 and the consumer device 14 to present payment options to a user of the consumer device and clear payment transactions for the marketplace server 14.

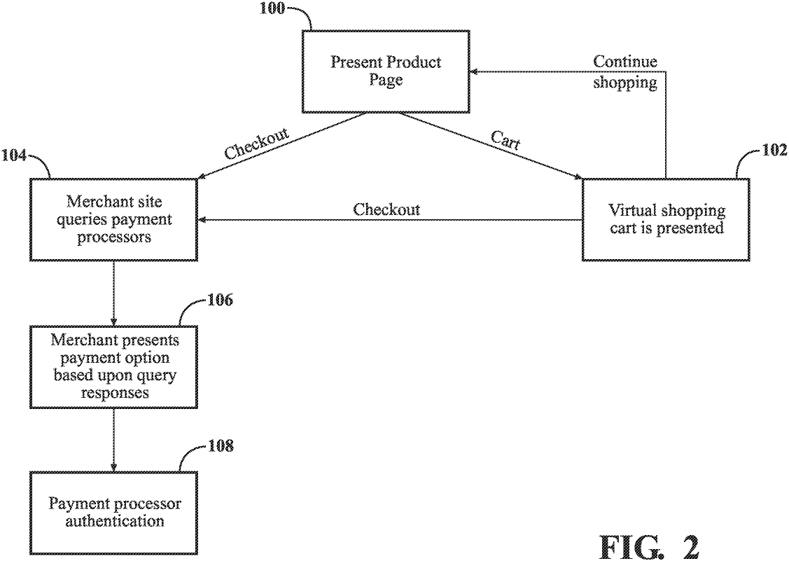

Referring now to FIGS. 2-5, there is shown a system for determining the content for a dynamically populated user interface feature presented on the consumer device 14, and more specifically the identity of a relevant payment processor for a specific consumer to present in an element for selecting that payment processor for payment of one or more products. In an embodiment, the element is an interactive element. The element may be any displayable element configured for selection but will be described herein as a “button”. In embodiments, the button is populated with a displayable element that indicates the identity of the payment processor, and clicking the button has the function of initiating the payment process for a product or service with that payment processor. In other embodiments, the interactive element may also include video or audio components or may be implemented in a form other than a displayable form (e.g. audio prompt), such as a voice prompt configured for speech recognition which may allow for selection. While the disclosure throughout contemplates using the apparatus, system and process disclosed to purchase products and services, for simplicity the below description will refer to products. All references to products throughout this disclosure should also be understood to be references to products and/or services.

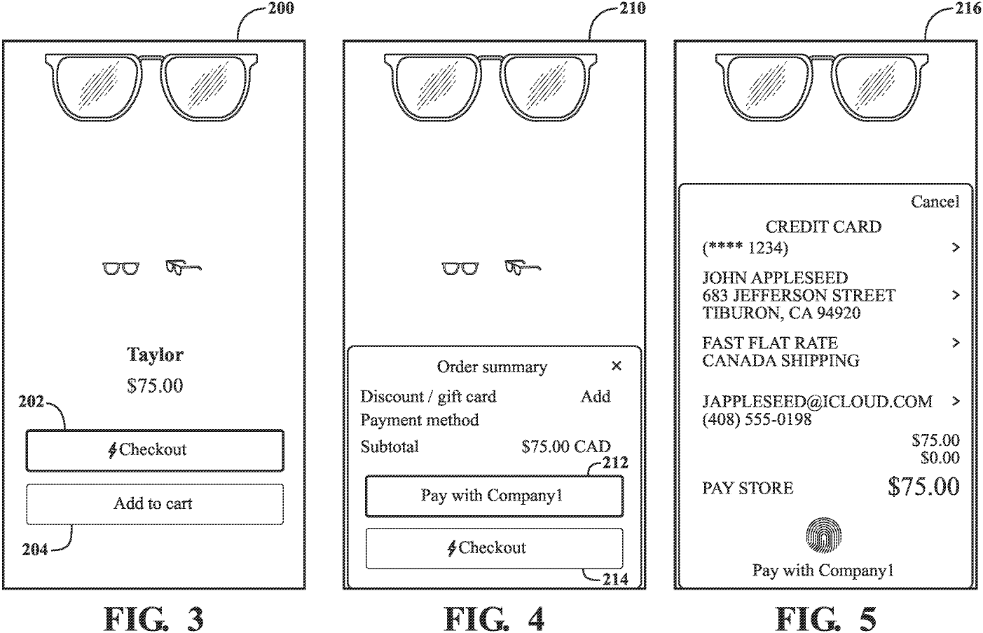

In FIG. 2, in a step 100, a product page 200 (FIG. 3) is presented to a consumer browsing a merchant site, where the product page 200 presents a product for purchase from the merchant through the site. In a first embodiment, the product page 200 presents at least two buttons relevant to the present embodiment - a checkout button 202 and a cart button 204. By selecting the cart button 204, in a step 102, the user is presented a display that includes a classic (virtual) shopping cart (not shown) with the product(s) placed therein and that may be modified to add or remove products, a selectable option to continue shopping, and a checkout button that leads to step 104 (described below).

In step 100 and from product page 200, there is also a checkout button that leads to step 104. At step 104, the merchant site queries one or more payment processors to determine whether and with which payment processor the present customer is recognized as having an account. If multiple requests are sent, the content, format and type of the requests sent may be the same for all payment processors i.e. a common or standardized request may be used. Alternatively, however, it is further contemplated that the content, format and type of request may be unique to each payment processor, browser, and/or electronic device, and for example, may comprise an API call, examining a cookie associated with the consumer’s browser or electronic device, involve properties of the consumer’s browser or electronic device (such as a plug-in or built-in capability of the browser or device), or comprise a query to the payment processor and an associated response.

Upon clicking on a button 202 (for example, when a consumer clicks on the button) requesting immediate checkout in a step 106, the consumer is presented with an order summary page 210 in FIG. 4 with at least two interactive buttons - a payment processor-specific checkout button 212 (“PPS checkout button”) and a customary checkout button 214 for completing a traditional checkout process. In embodiments, the order summary may be presented by a merchant site or the platform. In an alternative embodiment, the consumer may only be presented with a PPS checkout button 212 and skipping the order summary page, for example, if it is determined (e.g. by the merchant site or platform) that the consumer is recognized as having an account with at least one known payment processor.

By selecting (for example, where such selection is made by the customer) the PPS checkout button 212, in step 108, the consumer is presented (where such presentation may be done by the merchant site or the platform) with a payment authentication webpage 216 in FIG. 5 via which the consumer can undertake an authentication process to complete the transaction. The authentication process may be specific to the payment processor associated with the PPS checkout button 212 and may optionally be configured to receive a password, a pin number or a biometric authentication from the consumer, a third party or otherwise, such as a fingerprint scan, retina scan or facial recognition scan, to complete the payment.

The PPS checkout button 212 is populated with the identity of a payment processor with whom the customer was recognized as having an account, such that with a single selection of the PPS checkout button 212, the customer may advance the transaction to the authentication webpage 216. In an embodiment, the PPS checkout button is displayed with a logo and/or name of the payment processor and is displayed in a style or theme typically associated with the payment processor to assist in customer recognition of the payment processor.

Presentation of the order summary 210 page may be delayed until a response to requests for determining whether the customer has an account with the payment processors has been received from every payment processor queried and/or a timeout period has elapsed, or the order summary page 210 may display itself without a determination of the existence of an account regarding every payment processor and then insert the PPS checkout button 212 with the page 210 at a later point in time when the determination has been made. Optionally, a PPS checkout button 212 is displayed, but then not populated with the identity of the payment processor in the PPS checkout button 212 until a determination of the selected payment processor has later been made.

A logical operation (e.g. implemented as software code or instructions) to select the appropriate payment processor for the PPS checkout button 212 may be performed. In an example, the logical operation may be performed by the merchant site. In one embodiment, the logical operation selects the first payment processor determined to be a valid payment processor for the particular customer (e.g. with a valid account). In another embodiment, the logical operation randomly selects among payment processors determined to be valid. In another embodiment, the logical operation selects the payment processor from a preferred order of payment processors according to any of various factors, such as an existing marketing relationship with the customer or merchant, by selecting a lowest-cost payment processor or by selecting a payment processor with preferred authentication methods or security practices.

In further embodiments, the payment processor is selected based upon the browser which the customer is using or the type of electronic device the customer is using. For example, if the logical operation detects that the customer is using a certain brand of electronic device or a certain operating system, a payment processor that integrates best with the electronic device or operating system (such as payment processor that also manufactures the device or operating system) is preferred in the selection of a payment processor.

In further embodiments, the payment processor is selected according to geolocation data, such as by selecting (or eliminating) payment processors who indicate that they do (or do not) process payments based upon the customer’s current location. Geolocation data may also be used to select a currency for the transaction, or present to the customer multiple optional currencies for the transaction. Geolocation data of the customer may also be used for the merchant match with a merchant’s indications of a preferred currency. Currencies selectable for payment and default currencies also include cryptocurrencies. In embodiments where the currency and/or shipping address is integrated into the display of the PPS checkout button 212 to indicate the existence of default currency, shipping address and/or shipping method.

In embodiments, the payment processor is selected from payment processors with whom it is determined the consumer has an account and also based upon the customer’s past use of payment processors for either the present merchant or across many merchants, such as through the use of a cookie stored on the customer’s electronic device, an IP address, other identification or aggregation of information stored on the consumer’s device or on another device (e.g. a platform server servicing and/or connected with multiple merchant sites and storing identifiers of the payment processors used by the consumer across the merchant sites visited. For additional flexibility, the payment processor may also be selected based on the type or category of product being purchased, for example, to allow use of different accounts for different products or transactions.

In embodiments, a shipping and contact information page may be provided before or after the authentication page 216 for the customer to enter shipping and contact information. In another embodiment, the shipping and contact details information page is prepopulated with shipping and contact information received in response to a query to the payment processor for determination of an account with the payment processor (or a subsequent query specifically requesting shipping and contact information). The shipping and contact information may also be determined from a cookie or other information store located on the customer’s device. The shipping and contact details information page may further be configured to receive other information, such as desired shipping method, and discount codes from the customer and/or present further offers. In further embodiments, the PPS checkout button 212 may include an indication of a default shipping address and/or method of shipping that will be used if selected and a second PPS checkout button 212 that indicates that, if selected, a shipping address and method will be requested from the customer. Specifically, the default shipper address and/or method of shipping is presented by ensuring that the customer has an account with the payment processor; in a background process, querying the payment processor for the customer’s shipping address; determining the best shipping method possible for the address (for example, based upon speed and/or cost); and displaying the selected shipping method or address (or both) to the customer.

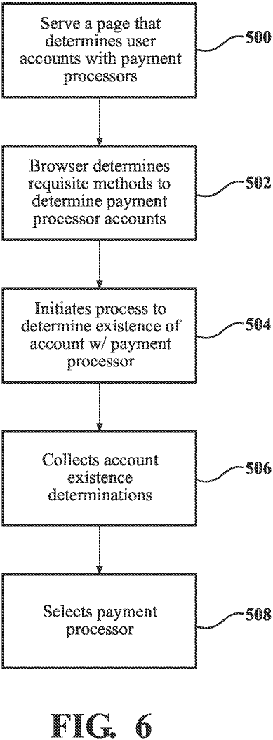

Other possibilities exist. In yet another embodiment, referring to FIG. 6, an electronic device, such as the consumer device or a browser of the consumer device, may be configured (e.g. with software code or instructions) to perform a logical operation for selecting a payment processor. For example, in a step 500, the consumer device or browser receives a page served from a website, such as the merchant site, a server hosting a website (e.g. the marketplace server 12) or another part of the platform 10, that includes software instructions for determining the existence of a customer account with one or more payment processors. The page which may for example be an online store page, a blog page, a social network page and may be served in many different ways, using elements obtained from one or more of a variety of sources which may be internal or external to the platform. In steps 502 and step 504, the consumer device / browser determines appropriate methods for determining valid payment processors and executes software instructions to initiate the requisite processes for determining the existence of a customer account with each payment processor. As described herein, that process may involve an API call, examining a cookie associated with the consumer’s browser or electronic device, involve properties of the consumer’s browser or electronic device (such as a plug-in or built-in capability of the browser or device), or comprise a query to the payment processor and an associated response. For example, if the software instructions are executed on a device where the payment processor software is built-in to the device or browser operating system, the process may comprise an API call and the API call only performed when the software instructions determine that the device or browser is present. Some payment processors may indicate a valid consumer account with cookies on the browser system, in which case the software instructions direct the browser to determine the existence and/or content of the cookie. In steps 506 and 508, the consumer device / browser collects account existence determination and selects a payment processor, as described herein.

Further yet, the software instructions may direct the device / browser to initiate a query across a network, such as a wide area network, to the payment processor(s) with information identifying the customer and to which a response is initiated which indicates whether the customer has an account with that payment processor. In one embodiment, software code is provided in response to a query for execution on the browser, such as Javascript, that remotely queries a payment processor’s server and the server returns a boolean result following this example format: { onboarded: true|false }. In another embodiment, the software code may instead be pre-installed on the consumer device / browser (e.g. via a downloadable software application) and may include instructions to query a payment processor’s server and the server returns a boolean result.

In yet another embodiment, to select a most appropriate payment processor for display in the PPS checkout button, the software instructions implement a scoring system. For the payment processors for which the software instructions will determine if a valid customer account exists, the software instructions will: 1) load dependencies necessary to be able to display the PPS checkout button 212 (“the ready step”), 2) use the appropriate method to determine the existence of an account with the payment processor (which may include a query over a network) (“the accelerated check”), and 3) execute software for continually scoring the payment processors until, during the completion of steps 1 and 2, a payment processor is selected when its cumulative score reaches a threshold score. In embodiments, the threshold score decreases over time. When a threshold score is met, the payment with the highest score is selected as the payment processor and displayed in the PPS checkout button 212.

During the ready step, in order to display the PPS checkout button 212, it may be necessary to first obtain external software code coming from the payment processor itself to display the PPS checkout button with the text, images and style of the payment processor. Once the process is complete, the PPS checkout button 212 is “ready” to be displayed and used and a score is attributed to the payment processor for being “ready”.

In the accelerated check step, once a payment processor has completed the ready check, as described above, the software instructions determine whether the customer is recognized as an account holder that can execute a transaction (or “onboarded”).

As the accelerated check is performed, payment processors that successfully complete the check are scored for being “accelerated.” In embodiments, the details of payment processor checks are not provided to the merchant website for privacy, as the accelerated check process is executed on the customer’s browser and electronic device.

Finally, as the ready step and accelerated check are performed to determine which of a plurality of payment processors will be selected for display in the PPS checkout button 212, the software instructions examine the scoring of each payment processor according to scoring criteria by continually re-evaluating scores of payment processors after the expiration of one or more predetermined periods of time and/or at the end of a total time duration, if reached. Any of the criteria for selecting payment processors for the PPS checkout button 212 described above may be used within the scoring process.

In this scoring system example, each payment processor has a current score and a maximum score (max score). The max score is in the best case when the payment processor passes the ready and accelerated check steps. The current score is the payment processor’s score at a given moment of time during processing of the ready step and the accelerated check. Each payment processor may also be assigned an initial score based upon a preference for a processor, as determined by a merchant and/or a customer, for example. A greater initial score for a payment processor generally equates to a greater chance for the payment processor to be selected.

As described herein, the scoring process is re-evaluated after the expiration of predetermined period(s) of time. When during an evaluation, a payment processor has received a score at or above the threshold score for selection, the payment processor is selected for presentation as the PPS checkout button 212. If more than one payment processor is over the threshold at the expiration of a time interval, in embodiments, the payment processor with the highest score is selected.

In another embodiment, the threshold score starts at the highest possible payment processor score and adapts with the results of all of the ready and accelerated checks of the payment processors. After a predetermined period of time, which can be one or more of the time periods for evaluating scores, if no payment processor has met the threshold score, the threshold score will be reduced according to a process for reducing the threshold score. For example, the process could be reducing the threshold score linearly or parabolically as a function of time. Additionally, if after a predetermined total period of time, no payment processor has met the threshold, but at least one payment processor has passed the ready and accelerated checks, the scoring process, in an embodiment, selects the payment processor with the highest score, even if below the threshold. In another embodiment, if no payment processor passes the accelerated check, a preferred payment is provided in the PPS checkout button 212 to invite the customer to create an account with the payment processor.

In an example, the scoring and selection process implements the following Javascript code section:

algorithm select-instrument is
let P be a set of Payment Instruments
where each member in P has a score and max-
score
let T be the amount of time that has elapsed
let D be duration to wait before reevaluating
select-instrument
for Pi in P do
if score(Pi) > threshold(T, max-score(P)) do
return Pi
else
reevaluate select-instrument after duration
D has passed

In a hypothetical operation of the above Javascript code section for implementation the scoring and selection process, the following given conditions exist:

The merchant uses Company1 and Company2 as payment processors.

The time duration for revaluation of scores is 500 ms.

Scores assigned:
Company1 { beginning: 0, ready: 40, accelerated: 50 }
Company2 { beginning: 0, ready: 1, accelerated: 49 }
Maximum possible score is Company1 being ready & accelerated (40 + 50 = 90)

At times T the code evaluates scores as below:
[T: 0 ms] Load both instruments ‘Perform ready check
[T: 500 ms] Company1 & Company2 are both ready, acceleration check starts
Current score: Company1 = 40, Company2 = 1. Threshold = 87.22 (inside function: x=500, y=90)
[T: 1000 ms] Acceleration check return Company1 false, Company2 true
Maximum score is now Company2 ready & accelerated (1 + 49) = 50
Current score: Company1 = 40, Company2 = 50 (1 + 49). Threshold = 38.88 (inside function: x=1000, y=50)
Company2′s score now meets the threshold and is selected at the 1 second mark.

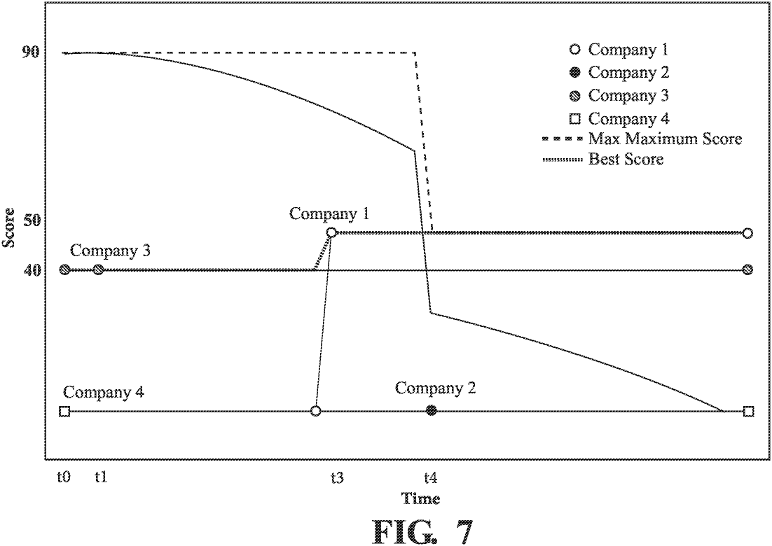

In an embodiment, and referring to FIG. 7, another payment processor selection process is disclosed where payment processors- Company1, Company2, Company3 and Company4- are selected. As shown in FIG. 7, at a time interval t0 checks are made with four payment processors to determine whether the processors are ready and accelerated. A max score is determined by the max score of the payment processor with the highest possible score and a threshold score is set equal to the max score and decreases as a function of time. Company3 is given a beginning score of 40 and has the best score. Company1, Company2 and Company4 are given beginning scores of 0.

At time interval t1, the status of the checks made with the payment processors is determined, and it is revealed that Company3 is not a payment processor with which the customer has an account. At interval t1, no payment processor has met the threshold score.

At time interval t2, the status of the checks made with the payment processors is determined and no changes have occurred in the check since time interval t1.

At time interval t3, it is determined that Company1 is ready and accelerated and its score is adjusted to 50, which represents the best score but remains below the threshold for payment processor selection.

At time interval t4, it is determined that the customer does not have an account with Company4. Since Company4 represented the highest possible score, the max score and the threshold score are reduced by Company4′s score. As a result, Company2′s score surpasses the threshold score in time interval t4 and is selected as the payment processor.

In the previous example, max scores can be set equally in order to select the payment processor that responds first. In other embodiments, scores may be assigned based upon payment processor preferences to allow preferred processors more time to respond and be selected before selection of less preferred processors. Preferred processors can be preferred based upon any factor, such as cost, technological sophistication of the processor, customer preference, merchant preference, or any other factor.

In the payment processor selection processes described, the initial set of payment processors may be determined based upon several factors, including location information of the merchant or the customer, as determined by address, geolocation data from a merchant or customer device, or an IP address of the customer or merchant, for example. For example, if a customer or merchant is present in a particular country, location data can be used to disqualify or qualify payment processors based upon their ability to process transactions in that country.

In embodiments, the determination of the payment processor can be performed on a client device or upon a remote device, such as a server, connected to the client device such as through a wide area network or the process may be segmented and performed upon a combination of the client device and a remote device. In embodiments, the process may be wholly performed on a client device or a remote device wherein the result is sent to the client device.

In embodiments, the present disclosure may be implemented in a physical retail location that may avoid the need for on-line stores, point of sale devices or presentation of product or service information in web pages. In such retail locations, products or service offerings may be tracked by camera or product identification tag, such as RFID devices, or by other means and customers may be charged for the products or services upon detection of a particular event such as a product being placed in a cart, the user (or product) passing a set location or exiting the retail location. In such retail locations, instead of presenting a payment processor-specific checkout element, a computing device may determine whether the user is recognized by one or more payment processors as having an existing account with each payment processor. When the user is identified as having an account with more than one payment processor, the computing device may request the user to select a preferred payment processor (e.g. via a voice prompt) or choose a payment processor from the payment processors with whom the user has an account according to a preference. Finally, the payment for the product or service is processed with the preferred payment processor based upon the user selection or the preference. The preference may be a highest score of payment processors with whom the user has an account based upon scores assigned to the payment processors. Alternatively, the payment processor may be a payment processor preferred by the user according to a user-defined preference order or may be selected according to any of the methods described herein described herein. In embodiments, the user and/or the merchant may be notified when there is no preferred payment processor available with whom the user has an account or if the transaction fails. Other possibilities exist for retail location implementations.

In another embodiment, and referring to Table 1 below, another payment processor selection process is described, where Company1, Company2 and Company3 compete for selection. In Table 1, in each row, a line ID, time value (in milliseconds), a value and a label for each value. In the embodiment, Company1 has a maximum score of 50 (1 point for ready and 49 points for accelerated), Company2 has maximum score of 10 (1 point for ready and 9 points for accelerated), and Company3 has a maximum score of 90 (40 points for ready and 50 for accelerated). As result, in the embodiment, a threshold score is set equal to 90 (the highest maximum score). The threshold score initially set equal to the maximum score and is reduced as a function of time, such as through a quadratic formula.

At a first time, in lines 1-2, Company3 responds that it is ready and is assigned 40 points. At a second time, in line 3-11, the threshold score is reduced based upon passage of time. At a third time, in lines 12-22, Company2 responds as ready and is assigned 1 point, and the threshold score is further reduced. At a fourth time, in lines 23-33, Company1 responds as ready and is assigned 1 point, and the threshold score is further reduced. At a fifth time, in lines 34-44, Company2 responds that accelerated is false. As a result, Company2 is awarded no further points, and the threshold score is further reduced. At a sixth time, in lines 46-57, Company3 respond with accelerated equals false. At a seventh time, in lines 59-71, the maximum score is reduced because the new maximum score is now Company2′s maximum score of 50. The threshold score is also reduced by 40 and further decreased based upon the passage of time. Also, during the seventh time, Company1 responds that accelerated equals true and is awarded a total of 50 points. Because Company1′s score of 50 surpasses the threshold score, Company1 is selected as the payment processor.

TABLE 1

| line ID | Time | Value | Label |
|---|---|---|---|
| 1 | 1533130953171 | Company3 -ready - true | Event |
| 2 | 1533130953171 | 40 | Company3 |
| 3 | 1533130953172 | 90 | Max Score |
| 4 | 1533130953172 | 89.99996 | Threshold |
| 5 | 1533130953172 | 0 | Company2 |
| 6 | 1533130953172 | 40 | Company3 |
| 7 | 1533130953172 | 0 | Company1 |
| 8 | 1533130953172 | 0 | Company2 |
| 9 | 1533130953172 | 40 | Company3 |
| 10 | 1533130953172 | 0 | Company2 |
| 11 | 1533130953172 | 0 | Company1 |
| 12 | 1533130953176 | Company2 -ready - true | Event |
| 13 | 1533130953176 | 1 | Company2 |
| 14 | 1533130953176 | 90 | Max Score |
| 15 | 1533130953176 | 89.99951 | Threshold |
| 16 | 1533130953176 | 1 | Company2 |
| 17 | 1533130953176 | 40 | Company3 |
| 18 | 1533130953176 | 0 | Company1 |
| 19 | 1533130953176 | 1 | Company2 |
| 20 | 1533130953176 | 40 | Company3 |
| 21 | 1533130953176 | 1 | Company2 |
| 22 | 1533130953176 | 0 | Company1 |
| 23 | 1533130953178 | Company1 -ready - true | Event |
| 24 | 1533130953178 | 1 | Company1 |
| 25 | 1533130953178 | 90 | Max Score |
| 26 | 1533130953178 | 89.99919 | Threshold |
| 27 | 1533130953178 | 1 | Company2 |
| 28 | 1533130953178 | 40 | Company3 |
| 29 | 1533130953178 | 1 | Company1 |
| 30 | 1533130953178 | 1 | Company2 |
| 31 | 1533130953178 | 40 | Company3 |
| 32 | 1533130953178 | 1 | |
| 33 | 1533130953178 | 1 | Company1 |
| 34 | 1533130953182 | Company2 - accelerated -false | Event |
| 35 | 1533130953182 | 1 | Company2 |
| 36 | 1533130953182 | 90 | Max Score |
| 37 | 1533130953182 | 89.99831 | Threshold |
| 38 | 1533130953182 | 1 | Company2 |
| 39 | 1533130953182 | 40 | Company3 |
| 40 | 1533130953182 | 1 | Company1 |
| 41 | 1533130953182 | 1 | Compapy2 |
| 42 | 1533130953182 | 40 | Company3 |
| 43 | 1533130953182 | 1 | Company2 |
| 44 | 1533130953182 | 1 | Company1 |
| 45 | 1533130953184 | 1 | Company2 |
| 46 | 1533130953187 | Company3 -accelerated -false | Event |
| 47 | 1533130953187 | 40 | Company3 |
| 48 | 1533130953187 | 1 | Company2 |
| 49 | 1533130953187 | 90 | Max Score |
| 50 | 1533130953187 | 89.99676 | Threshold |
| 51 | 1533130953187 | 1 | Company2 |
| 52 | 1533130953187 | 40 | Company3 |
| 53 | 1533130953187 | 1 | Company1 |
| 54 | 1533130953187 | 1 | Company2 |
| 55 | 1533130953187 | 40 | Company3 |
| 56 | 1533130953187 | 1 | Company2 |
| 57 | 1533130953187 | 1 | Company1 |
| 58 | 1533130953188 | 40 | Company3 |
| 59 | 1533130953190 | Company1 -accelerated -true | event |
| 60 | 1533130953190 | 50 | Company1 |
| 61 | 1533130953190 | 40 | Company3 |
| 62 | 1533130953190 | 1 | Company2 |
| 63 | 1533130953190 | 50 | Max Score |
| 64 | 1533130953190 | 49.99755 | Threshold |
| 65 | 1533130953190 | 1 | Company2 |
| 66 | 1533130953190 | 40 | Company3 |
| 67 | 1533130953190 | 50 | Company1 |
| 68 | 1533130953190 | 1 | Company2 |
| 69 | 1533130953190 | 50 | Company1 |
| 70 | 1533130953190 | 40 | Company3 |
| 71 | 1533130953190 | 50 | Company1 |
| 72 | 1533130953192 | 50 | Company1 |

In embodiments, one or any combination of the above-described payment processor selection processes may be implemented. Additionally, the above-described payment processor selection processes may be implemented to determine whether a PPS check out will not be displayed. The above-described processes can also be used in conjunction with factors, such as whether the customer has shopped with a particular merchant before, by the category of device being used, capabilities of the device being used (for example, if the device has near field communication capabilities), and if there is a default payment method enabled, such as through past behavior or pre-set defaults,

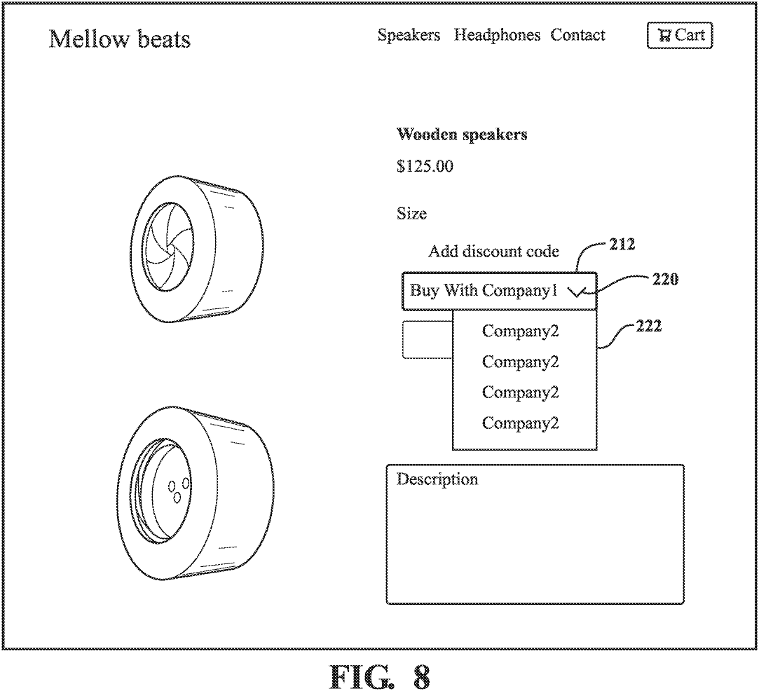

In embodiments, referring to FIG. 8, the PPS checkout button 212 includes an augmented user interface. For example, the button 212 itself may comprise a down-arrow portion 220 which when selected shows a dropdown 222 where other payment processors that were not selected but that responded positively for the customer being recognize as having a valid account are displayed. In some embodiments, the order in which payment processors are listed in the dropdown 222 is based on a scoring system such as described herein, and/or other considerations. For example, the context of the purchase can also be considered, such as timing, location and type of good or service. Moreover, any of the above factors can be used as part of a scoring process.

While the embodiments are described in the context of a webpage offering goods or services, and virtual cart for the same, the PPS checkout button may also be provided in any webpage, built into WORDPRESS or other theme, included in an application or any user interface of an application, included in any program, such as a video game, in a chat window and in a message thread or feed. Moreover, any of the embodiments described herein can be implemented by a merchant or merchant site on an ecommerce platform, or with a merchant or merchant site partially using an ecommerce platform or completely outside of an ecommerce platform.

In other embodiments, a feedback loop for selecting the payment processor for the PPS checkout button may be implemented. Elements of feedback in the system can include: whether a payment processor positively or negative affects sales, whether the consumer chooses to modify the transaction, whether certain choices were made through presentation of certain buttons, experiences of particular merchants or consumers to certain button presentations, and experiences of types of merchants or consumers to certain button presentations across merchants and users. In embodiments using a scoring system for example, the process may assign weighting to scoring factors based upon past experience to automatically apply accurate and responsive correction to the scoring function.

It is important to note that the PPS checkout button 212 is populated based a dynamic process and not only based upon pre-set user preferences. Rather, the dynamic process is executed at the time the button is being created/loaded. Also, the PPS checkout button 212 is not limited to a specific online merchant but can use information gathered from the merchant’s preferences and/or the customer’s preferences and behaviors across many online merchants. Further, multiple requests to gather information from payment processors are considered in populating the button, including requests to different payment processor platforms and requests of different types.

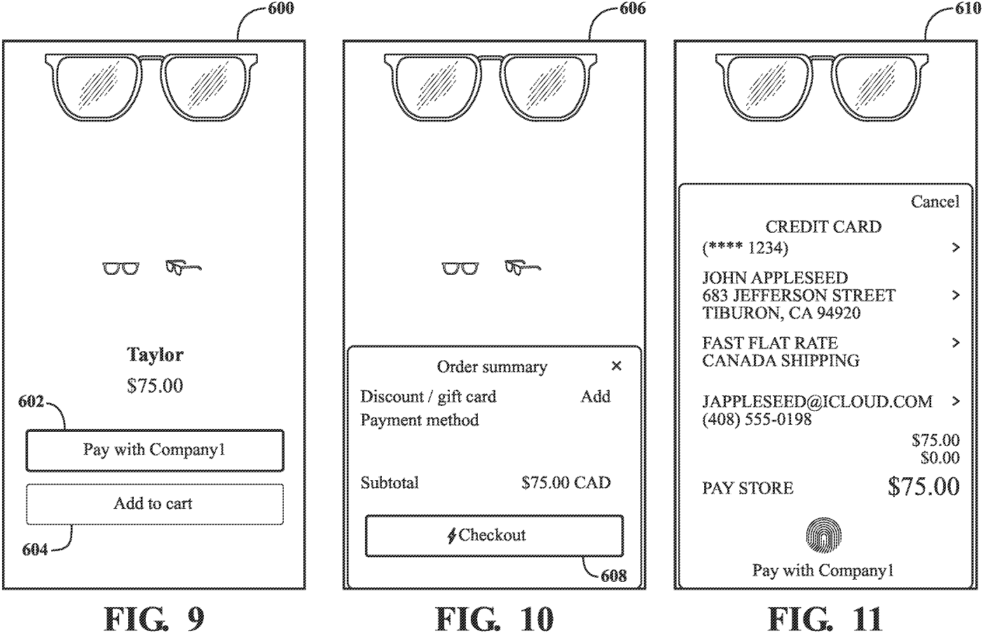

In the embodiment of FIGS. 2 and 3, the PPS checkout button 212 was implemented on an order summary page. However, referring to FIG. 9, on a product page 600, a PPS checkout button 602 is implemented adjacent to an add-to-cart button 604, whereby the payment processor selection process may be re-executed every time a customer views a product page on the merchant’s site. Alternatively, the payment processor selection process may be executed once per viewing session of a merchant’s website and the result of a previous selection process recalled for viewing of subsequent product pages 600 on the merchant’s site. As another alternative, the payment processor selection process may be executed once per period of time during a viewing session of a merchant’s website and the result of a previous selection process used for subsequent product pages 600 on the merchant’s site during the time period. In an embodiment, when the PPS checkout button 602 is displayed on a product page, the order summary page is displayed before the authentication page 216. Other possibilities exist for the placement of the PPS checkout button.

After the PPS checkout button 602 of FIG. 9 is selected by a customer, an order summary page 606 (FIG. 10) is displayed having a “complete transaction” button 608 and optionally providing a button providing the customer an opportunity to provide a shipping address and shipping method confirmation or entry. When the complete transaction 608 button is selected, an authentication page 610 (FIG. 11) is displayed providing the authentication method for the selected payment processor. In another embodiment, the order confirmation page 608 is not displayed after selecting the PPS checkout button 602, but rather the authentication page 610 is displayed.

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4^{th} Generation (4G) networks (e.g. Long Term Evolution (LTE)) or 5^{th} Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

What is claimed is:

1. A device comprising a processor and a computer-readable storage medium containing processor-executable instructions that, when executed by the processor, are to cause the processor to:
receive, from a marketplace server, a page for display on the device, the page including a product or service available for purchase from a merchant;
receive from, the marketplace server, software instructions for execution by the device to select a chosen payment processor from among a plurality of payment processors;
execute the software instructions, at the device, to select the chosen payment processor, wherein the software instructions cause the processor to,
for each payment processor, assign a score for that payment processor, adjust the score when it is determined that executable code is present on the device to enable display of a processor-specific checkout element for that payment processor, and further adjust the score when it is determined that a user associated with the device has an account with that payment processor, and
periodically compare the scores of the payment processors to a threshold level and select one of payment processors as the chosen payment processor based on the comparison of the score for that payment processor to the threshold level;
display, using the executable code present on the device, a selectable payment processor-specific checkout element within the page displayed on the device; and
receive a user selection of the selectable payment processor-specific checkout element to cause initiation of a payment process for the product or service with the chosen payment processor over the network.

2. The device of claim 1, wherein the software instructions further cause the processor to determine that the user of the device has an account with that payment processor by at least one of: executing an application programming interface on the device, examining a cookie stored on the device and associated with that payment processor, examining a property of a browser operating on the device where the property is associated with that payment processor, or transmitting a query to that payment processor and receiving a response from that payment processor.

3. The device of claim 1, wherein the selectable payment processor-specific checkout element is a button that includes at least one of a textual or design element identifying the chosen payment processor.

4. The device of claim 1, wherein the selectable payment processor-specific checkout element is not displayed within the page until the chosen payment processor is determined.

5. The device of claim 1, wherein the software instructions cause the processor to assign the score to each of the payment processors based on a user preference or a merchant preference.

6. The device of claim 1, wherein the software instructions causing the device to determine whether a user of the device is recognized by one or more payment processors as having an existing account comprises, for at least one of the payment processors, software instructions that direct the device to initiate a query across a network to the payment processor for determining whether the has an account with that payment processor.

7. The device of claim 1, wherein the software instructions further cause the processor to determine that that the executable code to enable display of the processor specific checkout element for that payment processor is not present on the device and, as a result, to transmit to that payment processor a request for the executable code.

8. The device of claim 1, wherein the software instructions cause the processor to adjust the score by increasing the score, to further adjust the score by further increasing the score, and to select the one of the payment processors based on that payment processor having a score above the threshold level.

9. The device of claim 8, wherein the software instructions cause the processor to reduce the threshold level at least once over a time during which it selects the chosen payment processor.

10. The device of claim 9, wherein the software instruction cause the processor to reduce the threshold as a result of determining that the user does not have an account with one of the payment processors, and wherein the threshold level is reduced by an amount of a maximum score associated with the one of the payment processors.

11. The device of claim 1, wherein the payment processor-specific checkout element further comprises a user display element that displays payment processors that are not the chosen payment processor, but for which the software instructions determined that the user has an existing account.

12. The device of claim 11, wherein the user display element is configured to display the payment processors that are not the chosen payment processor in a preference order.

13. A computer-implemented method comprising:
receiving at a device, from a marketplace server, a page for display on the device, the page including a product or service available for purchase from a merchant;
receiving from, the marketplace server, software instructions for execution by the device to select a chosen payment processor from among a plurality of payment processors;
executing the software instructions, at the device, to select the chosen payment processor, wherein the software instructions cause the processor to,
for each payment processor, assign a score for that payment processor, adjust the score when it is determined that executable code is present on the device to enable display of a processor-specific checkout element for that payment processor, and further adjust the score when it is determined that a user associated with the device has an account with that payment processor, and
periodically compare the scores of the payment processors to a threshold level and select one of payment processors as the chosen payment processor based on the comparison of the score for that payment processor to the threshold level;
displaying, using the executable code present on the consumer device, a selectable payment processor-specific checkout element within the page displayed on the device; and
receiving a user selection of the selectable payment processor-specific checkout element to cause initiation of a payment process for the product or service with the chosen payment processor over the network.

14. The method of claim 13, wherein the software instructions further cause the processor to determine that the user of the device has an account with that payment processor by at least one of: executing an application programming interface on the device, examining a cookie stored on the device and associated with that payment processor, examining a property of a browser operating on the device where the property is associated with that payment processor, or transmitting a query to that payment processor and receiving a response from that payment processor.

15. The method of claim 13, wherein the software instructions cause the processor to assign the score to each of the payment processors based on a user preference or a merchant preference.

16. The method of claim 13, wherein the software instructions causing the device to determine whether a user of the device is recognized by one or more payment processors as having an existing account comprises, for at least one of the payment processors, software instructions that direct the device to initiate a query across a network to the payment processor for determining whether the has an account with that payment processor.

17. The method of claim 13, wherein the software instructions further cause the processor to determine that that the executable code to enable display of the processor specific checkout element for that payment processor is not present on the device and, as a result, to transmit to that payment processor a request for the executable code.

18. The method of claim 13, wherein the software instructions cause the processor to adjust the score by increasing the score, to further adjust the score by further increasing the score, and to select the one of the payment processors based on that payment processor having a score above the threshold level.

19. The method of claim 18, wherein the software instructions cause the processor to reduce the threshold level at least once over a time during which it selects the chosen payment processor.

20. The method of claim 19, wherein the software instruction cause the processor to reduce the threshold as a result of determining that the user does not have an account with one of the payment processors, and wherein the threshold level is reduced by an amount of a maximum score associated with the one of the payment processors.
